(19) United States
(12) Patent Application Publication
(10) Pub. No.: US 2024/0353060 A1
(43) Pub. Date: Oct. 24, 2024

(54) PRESSURE VESSEL FOR GAS STORAGE HAVING STORAGE TUBES AND CONNECTION TUBE

(71) Applicant: TETRACELLS INC., Marietta, GA (US)

(72) Inventors: Mahmoud Alzahrani, Marietta, GA (US); Recep Gorguluarslan, Marietta, GA (US)

(21) Appl. No.: 18/641,253

(22) Filed: Apr. 19, 2024

Related U.S. Application Data
(60) Provisional application No. 63/460,775, filed on Apr. 20, 2023.

(51) Int. Cl. F17C 1/00

(52) U.S. Cl. CPC F17C 1/00; F17C 2201/0166; F17C 2201/0171; F17C 2221/012; F17C 2221/014

(57) ABSTRACT

Disclosure is a gas storage vessel for storing gas includes: a plurality of storage tubes formed as tubular bodies to form accommodation spaces for storing the gas therein, and at least one connection tube formed as a tubular body to form a connection space therein and coupled to the storage tubes to have a shared space where the accommodation spaces and the connection space intersect. According to an embodiment of the disclosure, a gas storage vessel for gas storage is provided which offers excellent coupling force between storage tubes and excellent scalability in gas storage capacity.

### REFERENCE TO RELATED APPLICATIONS

This application is based on and claims priority to U.S. Provisional Patent Application No. 63/460,775 filed on Apr. 20, 2023, the disclosure of which is incorporated by reference herein in its entirety.

### FIELD OF THE INVENTION

The disclosure relates to a gas storage vessel for gas storage arranged by combining at least one connection tube with a plurality of storage tubes.

### BACKGROUND OF THE INVENTION

In recent years, a gas storage vessel has become increasingly diverse, and safety standards for gas handling have been strengthened. Therefore, the gas storage vessel with a plurality of small-capacity storage chambers are widely utilized by arranged appropriately according to the installation environment are widely utilized.

For example, U.S. Pat. No. 5,577,630, a gas storage vessel disclosed which have a plurality of storage chambers arranged in parallel and a web made of composite materials surrounding the chambers arranged in parallel.

According to the aforementioned related technology, since the chambers arranged in parallel are only bound together by the web, there is a disadvantage in that a coupling force between the chambers is low. In installation environments where pressure and loads are strongly applied, such as in hydrogen fuel cell vehicles and hydrogen-powered personal air vehicles, the chambers may easily detach due to the limitations of the coupling force provided by the web, which may be a safety issue.

Furthermore, according to the aforementioned related technology, to increase the gas storage capacity of the gas storage vessel, chambers need to be added in the array direction. However, there is a problem of difficulty in adding the chambers when the installation space in the array direction is limited.

### SUMMARY OF THE INVENTION

An aspect of the disclosure is to provide a gas storage vessel for gas storage that enhances coupling force between gas storage chambers and improves scalability in gas storage capacity.

According to an embodiment of the disclosure, a gas storage vessel for storing gas includes: a plurality of storage tubes formed as tubular bodies to form accommodation spaces for storing the gas therein, and at least one connection tube formed as a tubular body to form a connection space therein and coupled to the storage tubes to have a shared space where the accommodation spaces and the connection space intersect.

The connection tube may interconnect one end portions of the storage tubes or positions between both end portions of the storage tubes. This enhances the coupling force between the storage tubes at various positions of the storage tubes.

The axial lines of the storage tubes and the connection tube may be arranged in a same plane or in different planes spaced apart from each other. This enhances the coupling force between the storage tubes in a structure where the axial lines of the storage tubes and connection tube are arranged in various planes.

The axial lines of the storage tubes and the connection tube may be orthogonal or have an inclined angle with each other. This enhances the coupling force between the storage tubes in a structure where the axial lines of the storage tubes and connection tube meet in various forms.

The storage tubes may include two or more tube groups stacked horizontally for each plane where the axial lines are arranged, and the connection tubes may be coupled to two or more tube groups. This enhances the coupling force between the storage tubes in a structure where the storage tubes are stacked.

The axial lines of the storage tubes may be arranged within a curved plane, and the connection tube may be contoured along the curved plane to be coupled to the storage tubes. This enhances the coupling force between the storage tubes in a structure where the axial lines of the storage tubes are arranged within the curved plane.

An inlet port may be provided on the storage tubes or the connection tube to allow the gas to be injected into the accommodation spaces or the connection space. This allows for diverse gas injection paths depending on the installation environment.

The inlet port may be provided at a central portion in a width direction of the connection tube. This prevents turbulence during gas injection.

The inlet port may include a neck portion protruding in a linear shape at one end portion of the connection tube, and the neck portion may protrude outward along the axial line of the connection space or inward along the axial line of the connection space. This facilitates the gas injection or prevents turbulence during the gas injection.

A valve for regulating an amount of the gas injected may be connected to the neck portion. This allows easy regulation for the amount of the gas injected.

A boundary portion where the storage tubes and the connection tube are mutually coupled can have shapes symmetric to the axial lines of the storage tubes and the connection tube. This increases the coupling area between the storage tubes and the connection tube, enhances the coupling force between the storage tubes.

Shapes of the tubular bodies may include at least one of circular, elliptical, rectangular, or hexagonal shapes. This allows the use of storage tubes and connection tube of various shapes depending on the installation environment.

The coupling may include at least one of welding, fusing, mechanical fastening, or brazing. This enhances the coupling force between the storage tubes in various ways.

According to an embodiment of the disclosure, a gas storage vessel for gas storage is provided which offers excellent coupling force between storage tubes and excellent scalability in gas storage capacity.

### BRIEF DESCRIPTION OF THE DRAWINGS

FIG. 1 illustrates a first gas storage vessel according to one embodiment of the disclosure.

FIG. 2 illustrates a second gas storage vessel according to one embodiment of the disclosure.

FIG. 3 illustrates a third gas storage vessel according to one embodiment of the disclosure.

FIG. 4 illustrates a fourth gas storage vessel according to one embodiment of the disclosure.

FIG. 5 illustrates fifth and sixth gas storage vessels having two or more tube groups related to FIG. 1 according to one embodiment of the disclosure.

FIG. 6 illustrates seventh and eighth gas storage vessels having two or more tube groups related to FIG. 3 or FIG. 5 according to one embodiment of the disclosure.

FIG. 7 illustrates ninth and tenth gas storage vessels having two or more tube groups related to FIG. 4 or FIG. 5 according to one embodiment of the disclosure.

FIG. 8 illustrates a neck portion of a connection tube according to one embodiment of the disclosure.

FIG. 9 illustrates a shape of tubular bodies according to one embodiment of the disclosure.

### DETAILED DESCRIPTION OF THE INVENTION

Below, exemplary embodiments will be described in detail with reference to accompanying drawings. In the drawings, like numerals or symbols refer to like elements having substantially the same function, and the size of each element may be exaggerated for clarity and convenience of description. However, the configurations and functions illustrated in the following exemplary embodiments are not construed as limiting the present inventive concept and the key configurations and functions. In the following descriptions, details about publicly known functions or features will be omitted if it is identified that they cloud the gist of the present inventive concept.

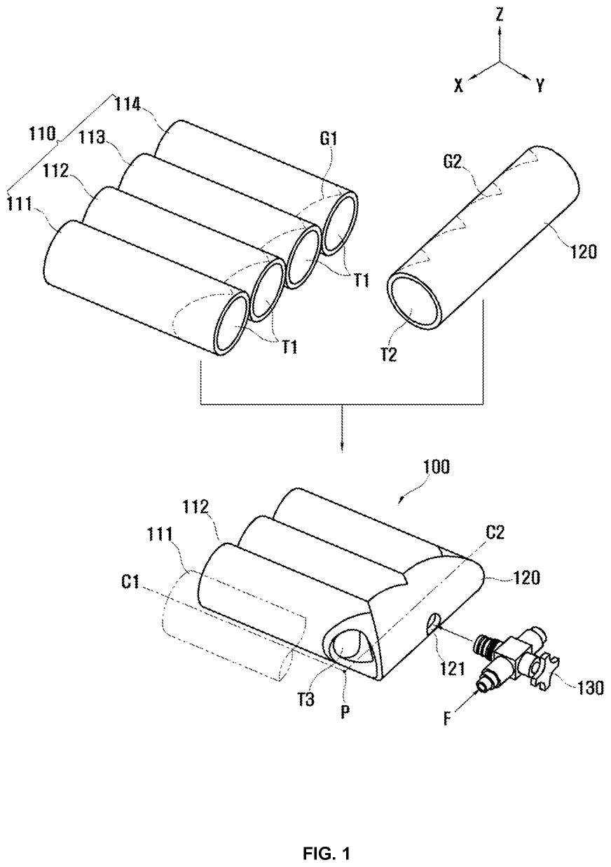

FIG. 1 illustrates a first gas storage vessel according to one embodiment of the disclosure.

As shown in FIG. 1, the first gas storage vessel 100 according to embodiments of the disclosure is intended for storing gas F. The gas F may include liquefied hydrogen, nitrogen, and the like, but is not limited thereto, and may include various fluids like gases and liquids stored under pressure.

For this purpose, the first gas storage vessel 100 may include a plurality of storage tubes 110 and at least one connection tube 120. The storage tubes 110 and the connection tube 120 may be referred to as longitudinal storage chambers and transverse storage chamber depending on the arrangement direction thereof, respectively.

The storage tubes 110 are tubular bodies that respectively form accommodation spaces T1 for accommodating the gas F therein, and the connection tube 120 is a tubular body that forms a connection space T2 therein.

The connection tube 120 is coupled to the storage tubes 110 so that the accommodation spaces T1 of the storage tubes 110 and the connection space T2 of the connection tube 120 intersect and overlap to have a shared space T3.

The gas F is charged and stored in the accommodation spaces T1 of the storage tubes 110 and connection space T2 of the connection tube 120 at high pressure. The storage tubes 110 and the connection tube 120 may be made of high-density polymer materials such as HDPE (High Density Polyethylene), PA6 (Poly Amide 6), or CFRP (Carbon Fiber Reinforced Plastic) for stable storage of high-pressure gas F. However, it is not limited thereto, and the storage tubes 110 and the connection tube 120 may be made of metal materials such as aluminum (Al), iron (Fe), copper (Cu), or their alloy materials.

For convenience of explanation, it is assumed that four storage tubes 111, 112, 113, 114 are arranged along the X-axis direction, and the connection tube 120 is coupled to these four storage tubes 111, 112, 113, 114. However, this is not limited thereto, the storage tubes 110 of various numbers may be arranged in a predetermined direction depending on the installation environment of the first gas storage vessel 100, and the connection tube 120 may also be coupled to the storage tubes 110 of various numbers arranged in the predetermined direction.

When the connection tube 120 is coupled to the storage tubes 111, 112, 113, 114, the shared space T3 is formed where the accommodation spaces T1 and connection space T2 intersect and overlap. Through this shared space T3, the accommodation spaces T1 of the storage tubes 110 and the connection space T2 of the connection tube 120 are mutually communicated.

Accordingly, since the connection tube 120 is individually coupled to each storage tube 111, 112, 113, 114, the coupling force between the storage tubes 111, 112, 113, 114 may be enhanced via the connection tube 120. With enhanced coupling force between the storage tubes 111, 112, 113, 114, even in installation environments where pressure and loads are strongly applied, such as in hydrogen fuel cell vehicles and hydrogen-powered personal air vehicles, the storage tubes 111, 112, 113, 114 are less prone to easy separation, thus enhancing the safety of the first gas storage vessel 100.

Furthermore, when the connection tube 120 is coupled to the storage tubes 111, 112, 113, 114, the storage space for gas F may be expanded by the volume remaining after subtracting the shared space T3 from the connection space T2, compared to the case that the gas F is only charged into the storage tubes 110. For example, in situations where the installation space is limited along the X-axis direction of the storage tubes 111, 112, 113, 114, and additional storage tubes cannot be installed, the gas storage capacity may be easily increased through the connection tube 120.

According to various embodiments, the connection tube 120 interconnects one end portions of the storage tubes 111, 112, 113, 114 along a longitudinal direction of the storage tubes 111, 112, 113, 114. In this case, the opposite ends of the storage tubes 111, 112, 113, 114 where the connection tube 120 is not coupled may be sealed.

When the connection tube 120 is coupled to one end portions of the storage tubes 111, 112, 113, 114, the shared space T3 may be formed on the side of the one end portions of the storage tubes 111, 112, 113, 114.

Accordingly, through the connection tube 120, the coupling force between the storage tubes 111, 112, 113, 114 at the one end portions of the storage tubes 111, 112, 113, 114 may be enhanced.

According to various embodiments, the axial lines of the storage tubes 111, 112, 113, 114 and the connection tube 120 are arranged in the same plane.

For the sake of explanation, it is assumed that the axial lines of the storage tubes 111, 112, 113, 114 are parallel within the X-Y plane, and the axial line C2 of the connection tube 120 is also arranged within the X-Y plane.

In this case, the axial line C1 of the first storage tube 111 and the axial lines of the remaining storage tubes 112, 113, 114 may intersect with the axial line C2 of the connection tube 120 at predetermined intersection points (P) within the X-Y plane.

Accordingly, the coupling force between the storage tubes 111, 112, 113, 114 may be enhanced in a structure where the axial lines of the storage tubes 111, 112, 113, 114 intersect with the axial line C2 of the connection tube 120 within the same plane,

According to various embodiments, the axial lines of the storage tubes 111, 112, 113, 114 and the axial line C2 of the connection tube 120 are mutually orthogonal.

For convenience of explanation, it is assumed that the axial lines of the storage tubes 111, 112, 113, 114 are all parallel within the X-Y plane, and the axial line C2 of the connection tube 120 is also arranged within the X-Y plane.

Additionally, it is assumed that the axial line C1 of the first storage tube 111 and the axial lines of the remaining storage tubes 112, 113, 114 are parallel to the Y-axis direction, and the axial line C2 of the connection tube 120 may be parallel to the X-axis direction.

In this case, the axial line C1 of the first storage tube 111 and the axial lines of the remaining storage tubes 112, 113, 114 can intersect orthogonally with the axial line C2 of the connection tube 120 at predetermined intersection points (P) within the X-Y plane.

Accordingly, the coupling force between the storage tubes 111, 112, 113, 114 may be enhanced in a structure where the axial lines of the storage tubes 111, 112, 113, 114 intersect orthogonally with the axial line C2 of the connection tube 120.

According to various embodiments, the axial lines of the storage tubes 111, 112, 113, 114 are arranged within a curved plane. The connection tube 120 is curved along the curvature of the curved plane to be coupled to the storage tubes 111, 112, 113, 114.

Accordingly, the coupling force between the storage tubes 111, 112, 113, 114 may be enhanced in a structure where the axial lines of the storage tubes 111, 112, 113, 114 are arranged within a curved plane.

According to various embodiments, an inlet port 121 is provided on either the storage tubes 111, 112, 113, 114 or the connection tube 120, to allow the gas F to be injected into the accommodation spaces T1 or the connection space T2.

In FIG. 1, a single inlet port 121 is shown provided on the connection tube 120, but this is not limited thereto, so a plurality of inlet ports 121 may be provided on the storage tubes 111, 112, 113, 114 or the connection tube 120. Additionally, the inlet port 121 may be used for discharging the gas F which is stored the storage tubes 111, 112, 113, 114 or the connection tube 120, a valve 130 for regulating the amount of gas F injected may be connected to the inlet port 121 according to various embodiments.

This allows for diverse gas injection paths depending on the installation environment.

According to various embodiments, the inlet port 121 may be located at the center along the width direction (Z-axis direction) of the connection tube 120.

If the inlet port 121 is not located at the center along the width direction, turbulence may occur during an injection process of the gas F. However, locating the inlet port 121 at the center along the width direction helps minimize turbulence and ensures stable injection of the gas F.

According to various embodiments, the coupling of the connection tube 120 to the storage tubes 111, 112, 113, 114 includes at least one of welding, fusing, mechanical fastening, or brazing. However, this is not limited thereto.

Welding provides the highest coupling force as it uses heat and pressure. Similar to welding, fusing uses heat, and offers lower coupling force compared to the welding. Mechanical fastening involves components like rivets, screws, bolts, making it easy to couple and detach the connection tube 120 to the storage tubes 111, 112, 113, 114. Brazing, conducted at lower temperatures, provides lower coupling force compared to welding, fusing, and mechanical fastening.

Accordingly, various methods may be employed to enhance the coupling force between the storage tubes 111, 112, 113, 114.

According to various embodiments, the storage tubes 111, 112, 113, 114 are cut along the first cut line G1 at the end where the connection tube 120 is coupled, and the connection tube 120 may be cut along the second cut line G2 on the side that couples to the storage tubes 111, 112, 113, 114.

For example, the boundary formed by cutting at the first storage tube 111 may have a shape symmetric to the axial line C1, and the boundary formed by cutting at the connection tube 120 may have a shape symmetric to the axial line C2. If the connection tube 120 has four boundaries, each may be coupled to the boundaries of the storage tubes 111, 112, 113, 114.

Accordingly, as the coupling area between the storage tubes 111, 112, 113, 114 and the connection tube 120 increases, the coupling force between the storage tubes 111, 112, 113, 114 may be enhanced.

However, the first cut line G1 and the second cut line G2 may be varied, resulting in various shapes of the boundaries formed accordingly. For example, depending on the various coupling relationships between the storage tubes 111, 112, 113, 114 and the connection tube 120, the first cut line G1 and the second cut line G2 may be arranged differently, and an area of the boundary may be increased. This allows to increase the coupling area between the storage tubes 111, 112, 113, 114 and the connection tube 120.

Therefore, the increase in the coupling area can further enhance the coupling force between the storage tubes 111, 112, 113, 114.

According to various embodiments, a polymer liner may be placed in the accommodation space T1, the connection space T2, and the shared space T3. The polymer liner may be implemented as a balloon, and be inflated to correspond to the internal shape of the accommodation space T1, the connection space T2, and the shared space T3 as the gas F is injected into the polymer liner. Therefore, the polymer liner can supplement the airtightness of the accommodation space T1, the connection space T2, and the shared space T3, thereby preventing the gas F from leaking to the outside.

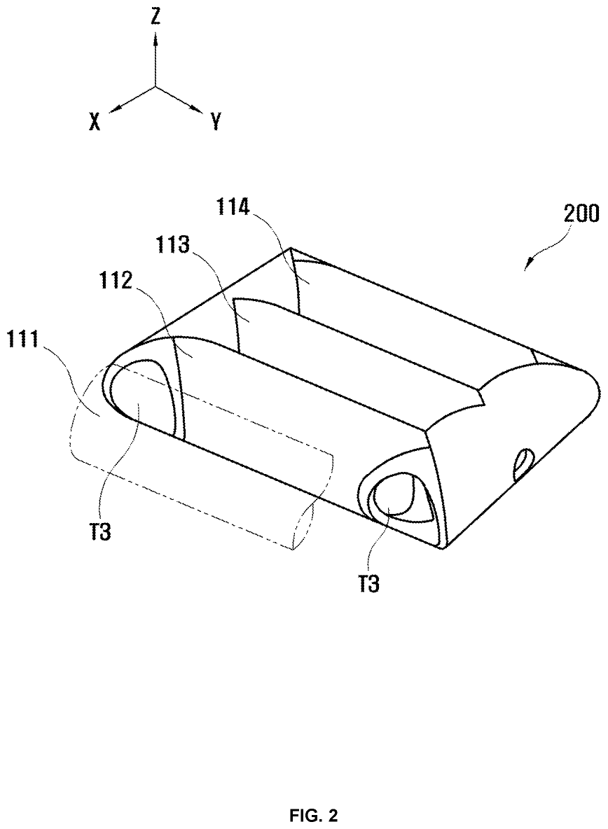

FIG. 2 illustrates a second gas storage vessel 200 according to one embodiment of the disclosure.

For convenience of explanation, the description identical to those in FIG. 1, i.e., the first gas storage vessel 100, is omitted here, and the focus is placed on the differences.

While in FIG. 1, the connection tube 120 interconnects one end portions of the storage tubes 111, 112, 113, 114, in this embodiment, a pair of the connection tubes 120 interconnects both end portions of the storage tubes 111, 112, 113, 114.

When the pair of the connection tubes 120 is coupled to both end portions of the storage tubes 111, 112, 113, 114, shared spaces T3 are formed at both end portions of the storage tubes 111, 112, 113, 114.

Therefore, compared to the case where the connection tube 120 interconnects one end portions of the storage tubes 111, 112, 113, 114, the coupling area between the storage tubes 111, 112, 113, 114 and the connection tube 120 increases, thereby enhancing the coupling force between the storage tubes 111, 112, 113, 114.

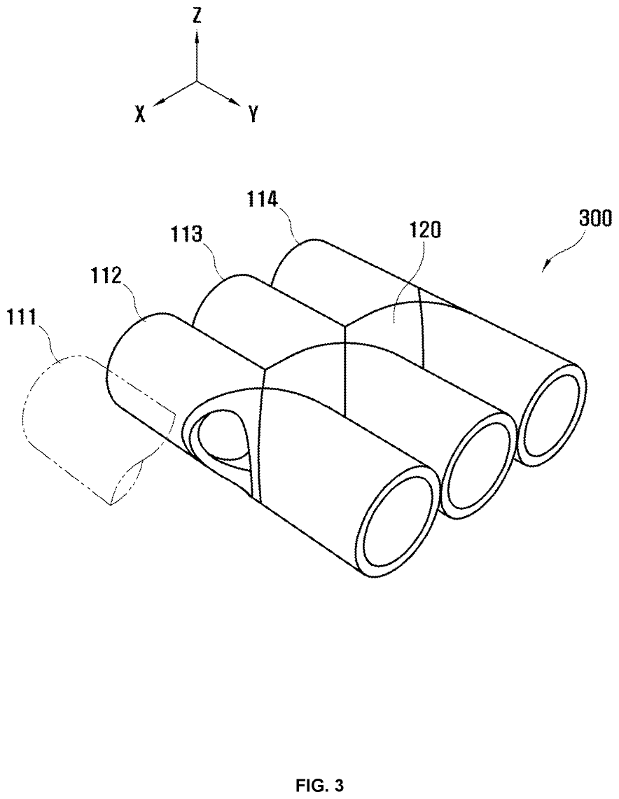

FIG. 3 illustrates a third gas storage vessel 300 according to one embodiment of the disclosure.

For convenience of explanation, the description identical to those in FIG. 1, i.e., the first gas storage vessel 100, is omitted, and the focus is placed on the differences.

In this embodiment of the third gas storage vessel 300, the connection tube 120 interconnects the positions between the both end portions of the storage tubes 111, 112, 113, 114 along their length direction.

Therefore, compared to the case where the connection tube 120 interconnects one end portions of the storage tubes 111, 112, 113, 114, the coupling area between the storage tubes 111, 112, 113, 114 and the connection tube 120 increases, thereby enhancing the coupling force between the storage tubes 111, 112, 113, 114.

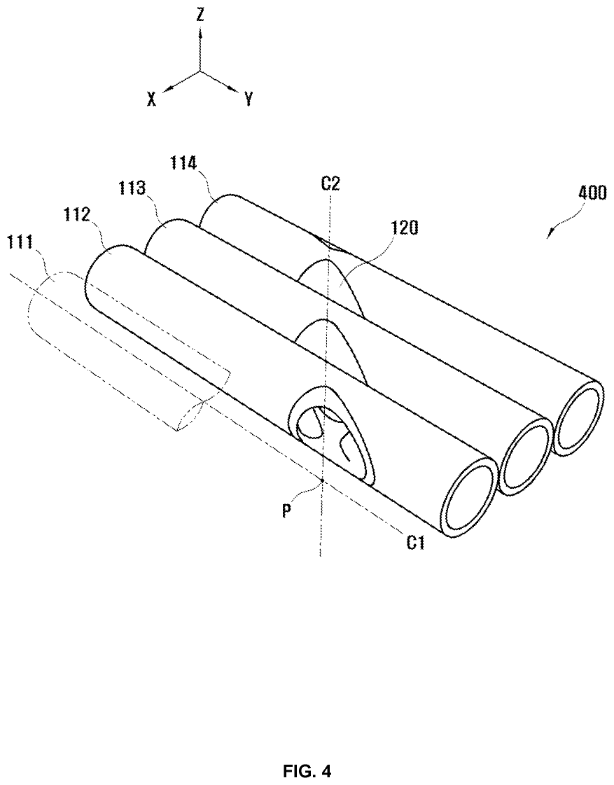

FIG. 4 illustrates a fourth gas storage vessel 400 according to one embodiment of the disclosure.

For convenience of explanation, the description identical to those in FIG. 1, i.e., the first gas storage vessel 100, is omitted, and the focus is placed on the differences.

In this embodiment of the fourth gas storage vessel 400, the connection tube 120 diagonally interconnects the positions between the both end portions of the storage tubes 111, 112, 113, 114. In other words, the axial lines of the storage tubes 111, 112, 113, 114 and the connection tube 120 have an inclined angle with each other.

For convenience of explanation, it is assumed that the axial lines of the storage tubes 111, 112, 113, 114 are all parallel within the X-Y plane, even if the axial line C1 of the first storage tube 111 and the axial line C2 of the connection tube 120 are within the X-Y plane, the axial line C1 of the first storage tube 111 is parallel to the Y-axis direction, while the axial line C2 of the connection tube 120 is not parallel to the X-axis direction. Thus, the axial line C1 of the first storage tube 111 and the axial line C2 of the connection tube 120 have an inclined angle at the intersection point P.

This increases the coupling area between the storage tubes 111, 112, 113, 114 and the connection tube 120, thereby enhancing the coupling force between the storage tubes 111, 112, 113, 114.

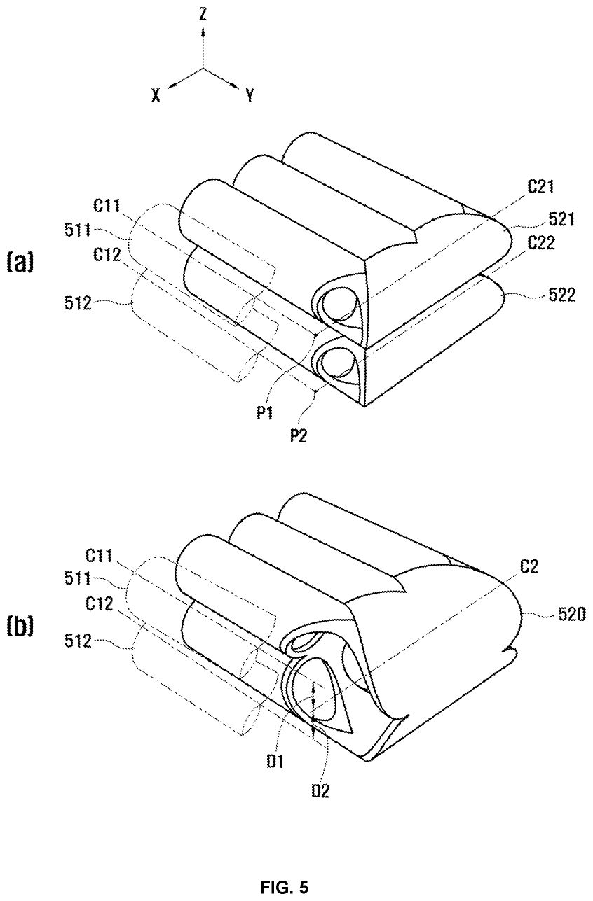

FIG. 5 illustrates a fifth gas storage vessel 500 and a sixth gas storage vessel 600 having two or more tube groups related to FIG. 1 according to one embodiment of the disclosure.

As shown in (a) of FIG. 5, the storage tubes comprise two or more tube groups. In the two or more tube groups, the axial lines of the storage tubes are arranged in two or more identical planes. The two or more tube groups are stacked in the Z-axis direction, which is horizontal with respect to each plane.

For example, the fifth gas storage vessel 500 comprises an upper tube group having upper storage tubes, including the first upper storage tube 511. The axial lines of the upper storage tubes may be arranged in the same plane as the upper plane.

Furthermore, the fifth gas storage vessel 500 comprises a lower tube group having lower storage tubes, including the first lower storage tube 512. The axial lines of the lower storage tubes can also be arranged in the same plane as the lower plane.

Since the upper plane is different from the lower plane, the upper tube group is stacked horizontally in the Z-axis direction with respect to the lower plane. For example, the first upper storage tube 511 is stacked on the first lower storage tube 512 in the Z-axis direction, and the remaining upper storage tubes are similarly stacked on the remaining lower storage tubes.

The connection tubes 521, 522 are coupled to storage tubes of two or more tube groups. For example, the upper connection tube 521 interconnects one end portions of the upper storage tubes, while the lower connection tube 522 interconnects one end portions of the lower storage tubes.

Of course, after the upper connection tube 521 interconnects one end portions of the upper storage tubes and the lower connection tube 522 interconnects one end portions of the lower storage tubes, it is also possible to stack the upper storage tubes and upper connection tube 521 over the lower storage tubes and lower connection tube 522.

This allows for enhancing the coupling force between the upper storage tubes and between the lower storage tubes in a structure where the upper storage tubes and the lower storage tubes are stacked.

According to various embodiments, the axial lines of the upper storage tubes and the axial line C21 of the upper connection tube 521 may be arranged in the same plane. In this case, the axial line C11 of the first upper storage tube 511 and the axial lines of the remaining upper storage tubes may intersect with the axial line C21 of the upper connection tube at a predetermined intersection point P1 within the X-Y plane, or they may be orthogonal depending on the situation.

Similarly, the axial line C12 of the first lower storage tube 512 and the axial line of the remaining lower storage tubes may intersect with the axial line C22 of the lower connection tube 522 at a predetermined intersection point P2 within the X-Y plane, or they may be orthogonal depending on the situation.

This allows for enhancing the coupling force between the upper storage tubes and between the lower storage tubes in a structure where the axial lines of the upper storage tubes and the upper connection tube 521 intersect or are orthogonal, and the axial lines of the lower storage tubes and the lower connection tube 522 intersect or are orthogonal.

According to various embodiments, as shown in (b) of FIG. 5, the sixth gas storage vessel 600 comprises an upper tube group having upper storage tubes including the first upper storage tube 511 and a lower tube group having lower storage tubes including the first lower storage tube 512.

However, unlike the fifth gas storage vessel 500, in this embodiment, a single connection tube 520 integrally interconnects one end portions of the upper storage tubes and one end portions of the lower storage tubes. For this purpose, the connection tube 520 may have a diameter larger than the diameter of the upper connection tube 521 or the lower connection tube 522 of the fifth gas storage vessel 500.

This allows for enhancing the coupling force between the upper storage tubes and the lower storage tubes by integrally interconnecting one end portions of the upper storage tubes and one end portions of the lower storage tubes with the single connection tube 520.

According to various embodiments, the axial lines of the upper storage tubes, the axial line of the connection tube 520, and the axial lines of the lower storage tubes are arranged within different planes spaced apart from each other in the Z-axis direction.

For example, there is a distance of D1 in the Z-axis direction between the axial line C11 of the first upper storage tube 511 and the axial line C2 of the connection tube 520, and there is a distance of D2 in the Z-axis direction between the axial line C2 of the connection tube 520 and the axial line C12 of the first lower storage tube 512.

This allows for integrating and coupling the upper storage tubes and the lower storage tubes in a structure where the axial lines of the upper storage tubes, the axial line of the connection tube 520, and the axial lines of the lower storage tubes are arranged within different planes spaced apart from each other, thereby enhancing the coupling force between the upper storage tubes and the lower storage tubes.

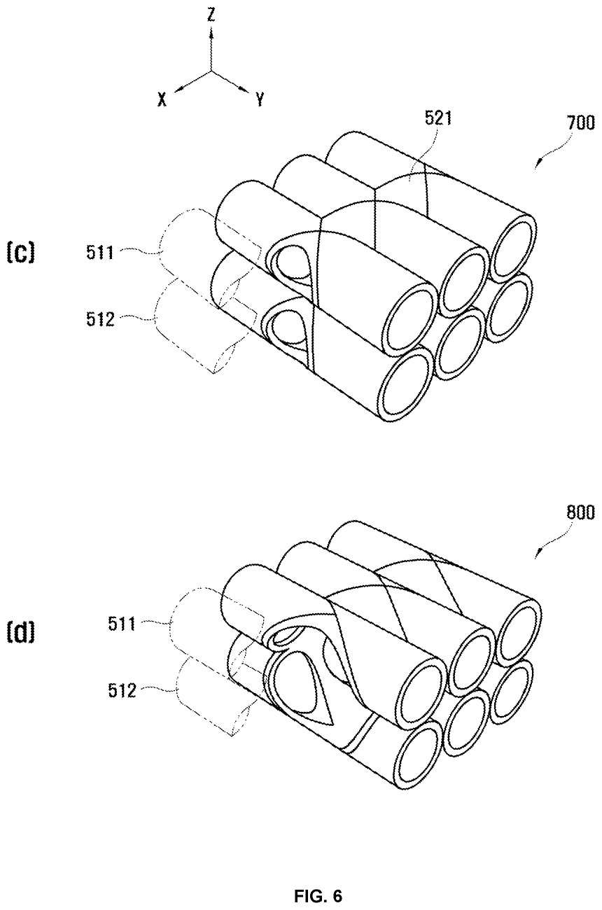

FIG. 6 illustrates a seventh gas storage vessel 700 and a eighth gas storage vessel 800 having two or more tube groups related to FIG. 3 or FIG. 5 according to one embodiment of the disclosure.

For convenience of explanation, the description identical to those in FIGS. 3 and 5, i.e., the third gas storage vessel 300 and the fifth gas storage vessel 500, is omitted, and the focus is placed on the differences.

As shown in (c) of FIG. 6, the seventh gas storage vessel 700 comprises an upper tube group having upper storage tubes including the first upper storage tube 511 and a lower tube group having lower storage tubes including the first lower storage tube 512.

The upper connection tube 521 interconnects the one end portions of the upper storage tubes, and the lower connection tube 522 interconnects the one end portions of the lower storage tubes.

This allows for enhancing the coupling force between the upper storage tubes and the lower storage tubes in a structure where the upper storage tubes and the lower storage tubes are stacked.

According to various embodiments, as shown in (d) of FIG. 6, the eighth gas storage vessel 800 comprises an upper tube group having upper storage tubes including the first upper storage tube 511 and a lower tube group having lower storage tubes including the first lower storage tube 512.

However, unlike the seventh gas storage vessel 700, a single connection tube 520 integrally interconnects the positions between the both end portions of the upper storage tubes and the lower storage tubes. For this purpose, the connection tube 520 may have a diameter larger than that of the upper connection tube 521 or the lower connection tube 522 of the seventh gas storage vessel 700.

This allows for integrating and coupling the upper storage tubes and the lower storage tubes, thereby enhancing the coupling force between the upper storage tubes and the lower storage tubes in a structure where the upper storage tubes and the lower storage tubes are interconnected by a single connection tube 520.

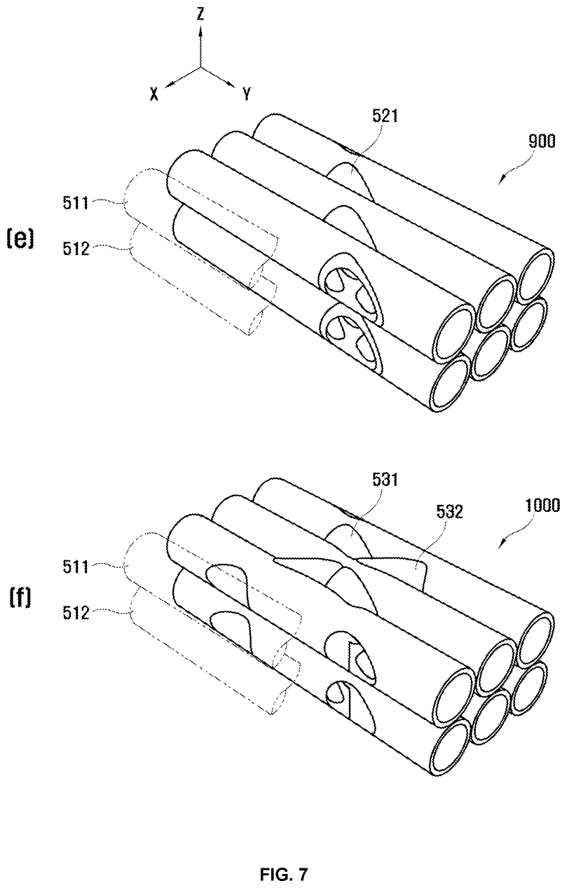

FIG. 7 illustrates a ninth gas storage vessel 900 and a tenth gas storage vessel 1000 having two or more tube groups related to FIG. 4 or FIG. 5 according to one embodiment of the disclosure.

For convenience of explanation, the description identical to those in FIGS. 4 and 5, i.e., the fourth gas storage vessel 400 and the fifth gas storage vessel 500, is omitted, and the focus is placed on the differences.

As shown in (e) of FIG. 7, the ninth gas storage vessel 900 comprises an upper tube group having upper storage tubes including the first upper storage tube 511 and a lower tube group having lower storage tubes including the first lower storage tube 512.

Similar to the fourth gas storage vessel 400 in FIG. 4, in this embodiment, the upper connection tube 521 diagonally interconnects the positions between the both end portions of the upper storage tubes. This means that the axial lines of the upper storage tubes and the upper connection tube 521 have an inclined angle.

Similarly, the lower connection tube 522 diagonally interconnects the positions between the both end portions of the lower storage tubes, like the upper connection tube 521. This means that the axial lines of the lower storage tubes and the lower connection tube have an inclined angle.

While the inclined angles in the upper and lower levels may be the same, they are not limited thereto, the inclined angles in the upper and lower levels may be different each other.

Therefore, by increasing the coupling area between the upper storage tubes and the upper connection tube 521, as well as between the lower storage tubes and the lower connection tube, the coupling force between the upper storage tubes and the lower storage tubes may be enhanced.

According to various embodiments, a single connection tube can also diagonally interconnect the positions between the both end portions of the upper storage tubes and the lower storage tubes.

For example, using the single connection tube 520 of the fifth gas storage vessel 500 in FIG. 5, the positions between the both end portions of the upper storage tubes and the lower storage tubes may be diagonally interconnected. The connection tube 520 may have a diameter larger than that of the upper connection tube 521 or the lower connection tube 522 of the ninth gas storage vessel 900.

Accordingly, in a structure where the upper storage tubes and the lower storage tubes are interconnected diagonally by the single connection tube, the upper storage tubes and the lower storage tubes are integrated and coupled for enhancing the coupling force between the upper storage tubes and the lower storage tubes.

According to various embodiments, as shown in FIG. 7 (f), a tenth gas storage vessel 1000 comprises an upper tube group having upper storage tubes including a first upper storage tube 511 and a lower tube group having lower storage tubes including a first lower storage tube 512.

In the ninth gas storage vessel 900, the single upper connection tube 521 diagonally interconnects the positions between the both end portions of the upper storage tubes, whereas in this embodiment, a plurality of upper connection tubes 531, 532 diagonally interconnect the positions between the both end portions of the upper storage tubes.

For example, a first upper connection tube 531 and a second upper connection tube 532 diagonally interconnect the positions between the both end portions of the upper storage tubes in a crossing manner. However, this is not limited thereto, and more than three upper connection tubes may be provided to diagonally interconnect in a crossing manner.

Similarly, with regard to the lower storage tubes, more than two lower connection tubes may be provided to diagonally interconnect the positions between the both end portions of the lower storage tubes in a crossing manner.

Accordingly, in a structure where the upper storage tubes and the lower storage tubes are diagonally interconnected by two or more connection tubes, the coupling force between the upper storage tubes and the lower storage tubes may be enhanced.

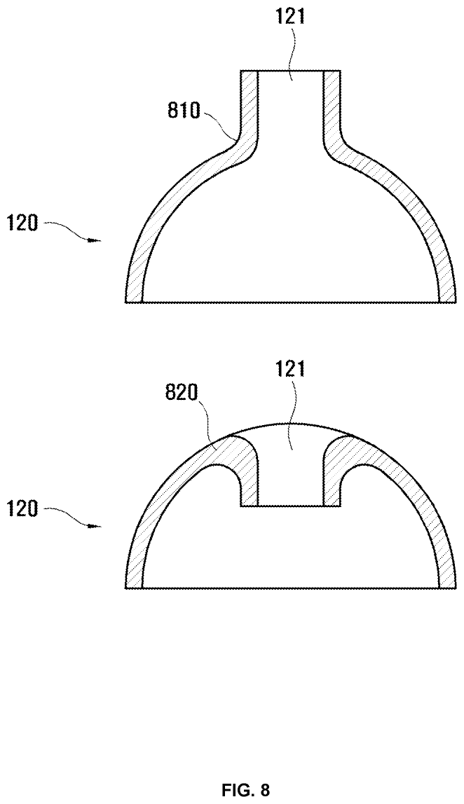

FIG. 8 illustrates a neck portion of a connection tube 120 according to one embodiment of the disclosure.

For convenience of explanation, the descriptions identical to those in FIG. 1, such as the first gas storage vessel 100, are omitted below, and the focus is on difference.

The neck portion protrudes from one end portion of the connection tube 120 in a linear shape. More specifically, the neck portion may be implemented as an outward neck portion 810 protruding from the outer side of the connecting space T2 along the axial line C2 of the connection tube 120, or an inward neck portion 820 protruding from the inner side of the connecting space T2 along the axial line C2 of the connection tube 120.

The outward neck portion 810 and the inward neck portion 820 facilitate smooth injection of the gas F, and the inward neck portion 820 can minimize turbulence during the injection process.

According to various embodiments, when the inlet ports 121 are provided at both end portions of the connecting end 120, the outward necks 810 or the inward necks 820 may be selectively arranged.

According to various embodiments, the valve 130 may also be coupled to the outward necks 810 or the inward necks 820, enabling easy regulation of the gas injection volume from the neck side.

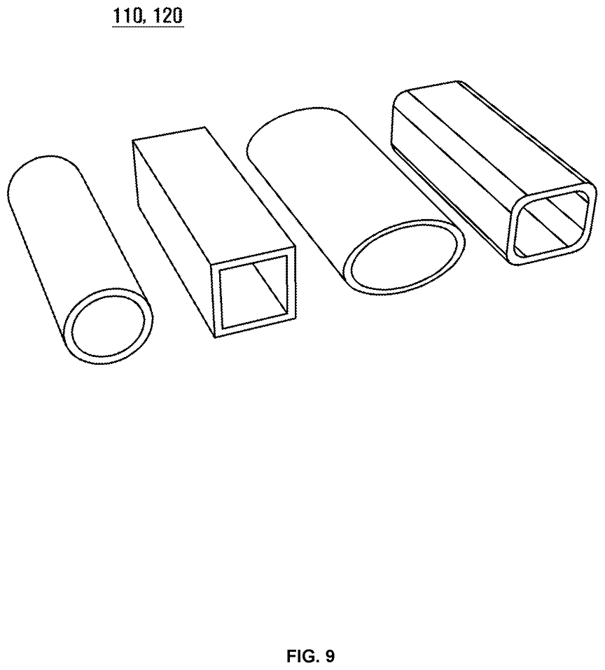

FIG. 9 illustrates a shape of tubular bodies according to one embodiment of the disclosure.

Although the shapes of the tubular bodies are illustrated as circular in FIG. 1, it is not limited thereto. Therefore, as shown in FIG. 9, the storage tubes 110 and the connection tube 120 having various shapes of the tubular bodies may be used depending on the installation environment.

In other words, the shapes of the tubular bodies may be at least one of a circular, oval, rectangular, or hexagonal shape, and in most cases, a rectangular may be used.

While the shapes of the tubular bodies are illustrated as circular in FIG. 1, it is not limited thereto, and various shapes of the storage tubes 110 and the connection tube 120 such as elliptical, rectangular, or hexagonal may be used depending on the installation environment, at least one of which may be other than circular.

Although exemplary embodiments of the disclosure have been shown and described, the disclosure is not limited to the foregoing specific embodiments, various alternative modifications can be embodied by a person having an ordinary skill in the art without departing from the scope of the disclosure as claimed in the appended claims, and such modified embodiments should not be understood separately from the technical spirit of prospect of the disclosure.

What is claimed is:

1. A gas storage vessel for storing gas comprising:
a plurality of storage tubes formed as tubular bodies to form accommodation spaces for storing the gas therein; and
at least one connection tube formed as a tubular body to form a connection space therein and coupled to the storage tubes to have a shared space where the accommodation spaces and the connection space intersect.

2. The gas storage vessel of claim 1,
wherein the connection tube interconnects one end portions of the storage tubes.

3. The gas storage vessel of claim 1,
wherein the connection tube interconnects positions between both end portions of the storage tubes.

4. The gas storage vessel of claim 1,
wherein axial lines of the storage tubes and the connection tube are arranged in a same plane.

5. The gas storage vessel of claim 4,
wherein the axial lines of the storage tubes and the connection tube are orthogonal.

6. The gas storage vessel of claim 4,
wherein the axial lines of the storage tubes and the connection tube have an inclined angle with each other.

7. The gas storage vessel of claim 1,
wherein axial line of the storage tubes and the connection tube are arranged in different planes spaced apart from each other.

8. The gas storage vessel of claim 1,
wherein the storage tubes include two or more tube groups of which the axial lines are arranged in a same plane and are stacked horizontally for each plane, and
the connection tube is coupled to the two or more tube groups.

9. The gas storage vessel of claim 8,
wherein the connection tube includes a plurality of the connection tube to be coupled to corresponding each of the two or more tube groups.

10. The gas storage vessel of claim 9,
wherein axial lines of each of the connection tubes have different inclined angles with respect to the axial lines of the storage tubes.

11. The gas storage vessel of claim 1,
wherein axial lines of the storage tubes are arranged within a curved plane, and
the connection tube is contoured along the curved plane to be coupled to the storage tubes.

12. The gas storage vessel of claim 1,
further comprising:
an inlet port provided on the storage tubes or the connection tube to allow the gas to be injected into the accommodation spaces or the connection space.

13. The gas storage vessel of claim 12,
wherein the inlet port is provided at a central portion in a width direction of the connection tube.

14. The gas storage vessel of claim 12,
wherein the inlet port comprises a neck portion protruding in a linear shape at one end portion of the connection tube.

15. The gas storage vessel of claim 14,
wherein the neck portion protrudes outward along an axial line of the connection space.

16. The gas storage vessel of claim 14,
wherein the neck portion protrudes inward along an axial line of the connection space.

17. The gas storage vessel of claim 14,
wherein the neck portion comprises a valve for regulating an amount of the gas injected.

18. The gas storage vessel of claim 1,
wherein a boundary portion where the storage tubes and the connection tube are mutually coupled has shapes symmetric to the axial lines of the storage tubes and the connection tube.

19. The gas storage vessel of claim 1,
wherein shapes of the tubular bodies comprises at least one of circular, elliptical, rectangular, or hexagonal shapes.

20. The gas storage vessel of claim 1,
wherein the coupling comprises at least one of welding, fusing, mechanical fastening, or brazing.
